(19) United States
(12) Patent Application Publication
(10) Pub. No.: US 2010/0240391 A1
(43) Pub. Date: Sep. 23, 2010

(54) LOCATION DETECTION

(76) Inventor: Gordon Povey, Kirkcaloy (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/447,174

(22) PCT Filed: Oct. 31, 2007
(86) PCT No.: PCT/GB2007/004151

§ 371 Date: May 6, 2010

(30) Foreign Application Priority Data
Oct. 31, 2006 (GB) 0621625.3

(51) Int. Cl. H04W 24/00

(52) U.S. Cl. 455/456.1

(57) ABSTRACT

A method for detecting the location of a user terminal in a telecommunications network comprising: receiving network information from the terminal and using the signal from the terminal and a netlist (4C) to determine or predict the location of the terminal. The netlist (4C) can be represented as a state diagram with interconnections being associated with probabilities. As a simple example, the probability of moving from cell A to cell B is 0.7 (0.14+0.56). However, if the previous cell was D, the probability of moving from cell A to cell B is reduced to 0.56.

The present invention relates to a method for monitoring cell interconnections within a telecommunications network, thereby to enable a cellular terminal to be located within that network.

### BACKGROUND OF THE INVENTION

Conventional methods for locating a cellular terminal employ so called cell of origin techniques. Normal practice is for the cellular terminal to couple with one particular base station, typically the base station located closest to the cellular terminal. The location of the centre of the cell associated with that base station is then assumed to be the approximate location of the cellular terminal. As the cellular terminal moves between cells its approximated location moves from being the middle of the first cell to being the middle of the second cell, as determined by the network server.

Whilst some location information can be derived using cell of origin techniques, the location accuracy is limited since it is largely dependent on the size of cells and so can generally only be approximated to within the cell radius. Furthermore, there is often a latency experienced in the location information since it is normally sourced from the cellular network operator. The operator may provide only the last known cell location that in practice could be many minutes old.

Satellite-based global positioning systems (GPS) can also be used to determine the location of mobile terminals. GPS solutions are generally more accurate than cell of origin methods but are significantly more expensive and have restricted use when required to operate indoors. Alternatively, triangulation techniques can be used. These generally involve recording signal of arrival measurements and are known to be reasonably accurate. However, triangulation methods require additional equipment, processing and communications at the network side or require measurements to be made using modified or specialised terminal equipment.

In an improved mobile phone location system the approximate location of the handover from one cell to an adjacent cell is used to compute a mobile phone location when such a handover event occurs. For example, FIG. 1 shows a mobile terminal located in a handover region between two adjacent cells 3. By storing the location of handover events in a handover location database, the location of the terminal can be determined when a handover event is detected. This is described in more detail in co-pending international patent application PCT/GB2005/001656, the contents of which are incorporated herein by reference.

### SUMMARY OF THE INVENTION

The present invention uses a netlist, i.e. knowledge of cellular cell and/or sector and/or segment interconnections, in order to predict a relative, absolute or future location of a mobile terminal within a cellular or wireless network. This can be done even with very limited or no prior knowledge of the physical cellular or wireless network.

According to one aspect of the invention, there is provided a method for detecting the location of a user terminal in a telecommunications network comprising: receiving network information from the terminal and using the signal from the terminal and information in a netlist, such as cell and/or sector interconnection information, to determine the terminal location.

The netlist may be floating and not anchored to any particular location, and determining the terminal location may involve determining the relative location of the terminal. One or more locations within the floating netlist may be tagged with a label, for example “work” or “home”.

Using a floating netlist allows relative proximity to be determined, for example distance between objects. This can be used to ascertain which objects within a netlist are far away and therefore not relevant. By tagging a location within the netlist, proximity to the tag can be calculated, so that it is possible to determine if the device is at the office or far away from it.

By using relative location the ‘system’ has no knowledge of the actual physical location of a device. This overcomes many privacy issues and satisfies concerns about the storage and sharing of personal location data. This use of a floating netlist enables proximity to be determined even when no physical location data is known. Proximity is useful in many applications such as finding how close you are to certain groups of friends. This can assist when determining what objects or content, e.g. promotional material, are relevant at any particular time.

The method may involve anchoring at least one point within the netlist to a known physical location and using the at least one anchor point and the netlist to estimate the location of the terminal. The physical location of only a subset of points within the netlist needs to be known in order to estimate the probable location of a terminal within the netlist. Using time of flight or time synchronisation information (e.g. timing advance (TA) in GSM and potentially signal strength data for adjacent cells, e.g. network measurement reports (NMR) in GSM) data combined with good anchor points can lead to a highly accurate location detection system.

The method may involve determining relative proximity of two objects by establishing a minimum number of hops across cells and/or sectors or segments of sectors and/or cells of the network as defined in the netlist in order to join the two objects together. The cell coverage areas may vary in size and so the distance of the or each hop varies. The relative separation of the two objects may be approximated using a normalised hop distance. Timing information may be used between hops to estimate the size of each cell. Objects that are far away may be identified.

Information received from the terminal may be used to detect changes in the network and/or change in or up-date the netlist.

Information received from the terminal may be used to predict a probable route or next location for the terminal. This may be done using transition probabilities within a netlist.

Information may be received from the terminal periodically and/or when network changes are detected.

According to another aspect of the invention there is provided a system for detecting the location of a user terminal in a telecommunications network comprising: means for receiving network information from the terminal and means for determining the terminal location using the signal from the terminal and information in a netlist.

The netlist may be a floating netlist, and the determining means may be operable to determine the relative location of the terminal.

At least one point within the netlist may be associated with a known physical location and the means for determining may be operable to use the at least one anchor point and the netlist to estimate the location of the terminal.

The determining means may be operable to determine the relative proximity of two objects by establishing a minimum number of hops across cells and/or sectors or segments of sectors and/or cells of the network as defined in the netlist in order to join the two objects together.

The cell coverage areas may vary in size and so the distance of the or each hop varies. The determining means may be operable to approximate the relative separation of the two objects using a normalised hop distance. The determining means may be operable to use timing information between hops to estimate the size of each cell.

In accordance with the invention, there is provided a method for building a location detection system with limited, partial or no initial knowledge about the host cellular network. This can be done by monitoring a netlist associated with the network. This enables the implementation of location and context-aware applications without the need for accurate and up-to-date knowledge of the cellular network topology. This can be used in any location-based service, location-aware service or context-aware service that requires relative location data, absolute location data or future location prediction data.

Additionally a ‘live’ netlist enables dynamic data about a cellular network to be gathered. This can be useful for maintaining the netlist and providing the cellular operator with data on the performance of their network.

In accordance with another aspect of the invention there is provided a method for constructing a netlist by monitoring the movement of live terminals within the network and reporting network data periodically as it changes. This enables the interconnection of cells, sectors and segments to be determined with no prior knowledge of the network, as well providing statistics relating to ‘journeys’ through the network. Alternatively, the netlist can also be derived via drive tests, probes or surveys designed to measure and map out the network including those using GPS receivers in conjunction with network monitoring equipment.

In accordance with yet another aspect of the invention there is provided a method for constructing a netlist by predicting probable handover regions based on cell coverage data, a handover being likely where two cell coverage regions intersect. This coverage data can be based on coverage predictions (e.g. from cellular network planning tools), measured coverage data or a combination of the two.

It is difficult to obtain data about every physical location within a network but it is much easier to obtain partial knowledge. The netlist allows the location detection system to operate on this partial data set. The netlist and the anchor method allow the location accuracy to be improved in line with improving anchor point data. Knowledge of the netlist and physical anchor points allows a physical location and location tracking system to be implemented.

The actual physical location can be determined or estimated if the netlist is anchored in places to known locations. The more anchor points that are known throughout the network, the more accurate the physical location estimates will become. Methods of anchoring the locations include the use of known network data (e.g. provided by the cellular operator), or by using data that may have been collected by GPS receivers.

According to yet another aspect of the invention there is provided a method for detecting network changes comprising comparing recent network information from a device to an existing netlist. Detected changes can be used to update the location databases, including the netlist, so that they reflect the current network status. The network operators can use bulk data gathered to show the performance of the network.

According to yet another aspect of the present invention there is provided a method for predicting a location of a device and possibly the likely destination or potential destinations for that device comprising determining transition probabilities that have been measured within the netlist. The method also allows the elimination of highly unlikely destinations.

Providing a method for predicting the next location of a user is advantageous in a number of scenarios, such as for the delivery of services. This is because it is often more useful to know where someone is going rather than where they currently are. For example, this method could be used to make traffic data relevant. When travelling towards a certain town localised adverts can be provided to the user's terminal rather than general ones.

In one aspect, the invention uses cell interconnection information to compute the probable location of cells and cell handovers when this is not known. Using knowledge of the cell interconnections and an incomplete knowledge of the network topography, it is possible to implement a mobile telephone location system.

The system and method of the invention are operable to use cell interconnection information to monitor connections in a network based on observed interaction with a terminal and carry out any one or more of the following advantageous functions: detect changes in the cellular network; predict the probable route or next location using observed statistics; repair a location database when the cell-ID of a cell or group of cells is changed and derive data on the coverage and handover behaviour of cellular networks.

### BRIEF DESCRIPTION OF THE DRAWINGS

Various aspects of the invention will now be described by way of example only and with reference to the accompanying drawings, of which:

FIG. 2 is a block diagram of a location information store that includes information that can relate data received from a mobile terminal to an output that is indicative of the location of that terminal within a telecommunications network;

FIG. 3 is schematic diagram of an idealized cellular network showing cells and their handover interconnections;

FIG. 4 is an illustration of netlist data used to show predicted network topography and coverage over a map

FIG. 5a is an illustration of how location uncertainty grows with each handover if the handover location is not known;

FIG. 5b is an illustration of how a netlist can be used to estimate the locations for unknown handovers;

FIG. 6a is an illustration of how a netlist can be used to estimate the locations for unknown handovers based on two known handover locations;

FIG. 6b is an illustration of how a netlist can be used to estimate the locations for unknown handovers based on three known handover locations;

FIG. 7 is a schematic view of a possible cell layout based on netlist data;

FIG. 8a is a schematic view of a possible cell and interconnection layout after three iterations of a layout estimation algorithm;

FIG. 8b is a schematic view of a possible cell and interconnection layout determined using the layout estimation algorithm used for FIG. 8a, but after convergence;

FIG. 9 is a schematic view of the cell and interconnection layout of FIG. 8b when weighted by the minimum distance to a known cell;

FIG. 10 is a schematic view of a handover between two cells that appear to be physically far apart;

FIG. 11a is a schematic view of a handover when an unknown cell is introduced into the network;

FIG. 11b is a schematic view of a handover between two known cells of FIG. 11a;

FIG. 12 is an illustration of a method for predicting a next location using conditional handover probability;

FIG. 13 is a schematic view of how a netlist can be repaired using known anchor points;

FIG. 14 is an illustration of a method for predicting cell coverage, and

FIG. 15 is shows cells, sectors and segments and a device moving through this network.

### DETAILED DESCRIPTION OF THE DRAWINGS

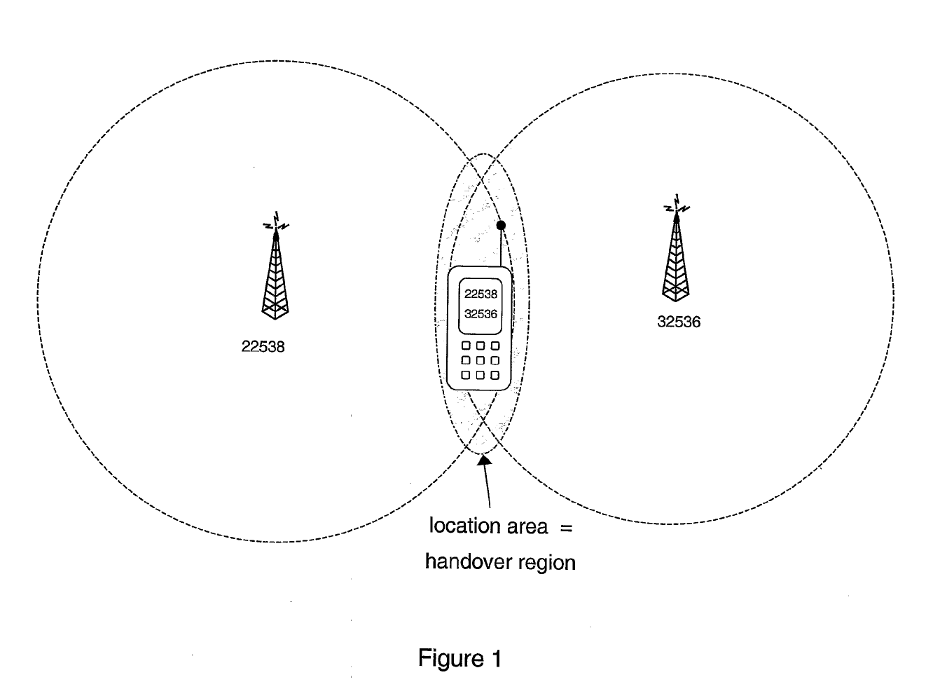

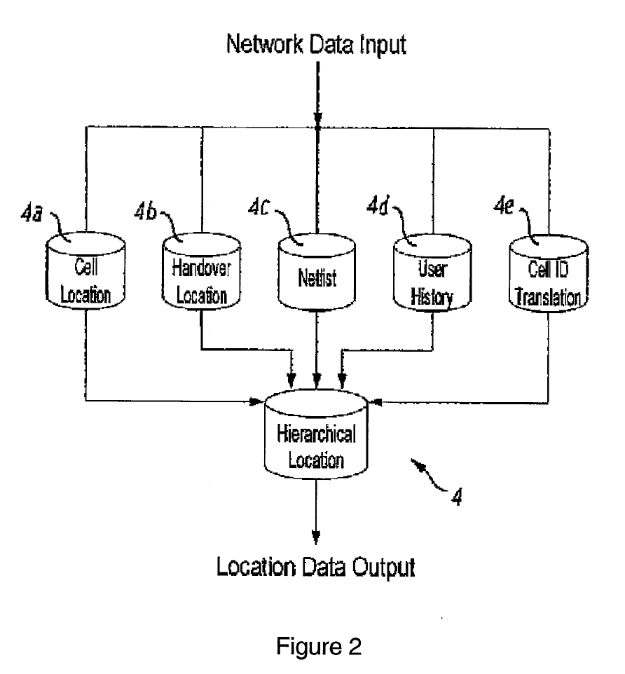

To locate a cellular terminal, the terminal has to include a software application and/or hardware that allows it to communicate with a location server/processor that is operable to use signals received from that terminal to determine its location. Any suitable form of server or computer processor can be used, provided it is adapted to receive and process information from the terminals. The location server/processor is separate from the servers/processors of the network providers. Typically, the server/processor includes or is operable to communicate with a location information database, such as that shown in FIG. 2.

The location information database of FIG. 2 includes a cell location database that holds a record of cell IDs against physical location for the centre of that cell coverage. This information is used to calculate data for inclusion in the handover database. The handover database includes data for cell handover pairs (or triples or quads) and their corresponding locations. A netlist database provides a record of how cells and/or sectors are connected to each other. The netlist data may be defined by observed or predicted handovers. This could be populated with some information at the time of system set-up or may be populated by observed interactions with cellular terminals. A user history database is used to hold historical location data for each cellular terminal. This is simply a log of the handover, time of handover and other data observed for each cellular terminal. A cell ID translation database provides a look-up table that is able to translate between cell IDs used by the network operators and those IDs used internally within the methods describe herein. In practice, a separate location information database may be required for each network provider. However, it will be readily apparent to those skilled in the art that all the data could be combined within a single database.

The terminal software application is employed to access information contained within the cellular terminal and is specifically designed to be initiated when the cellular terminal is powered up and thereafter operate as a background task. For example the software application can be employed to read the following information from the cellular terminal: (i) the network provider name; (ii) the cell of origin ID; (iii) the location area code; (iv) the signal strength and timing or synchronisation offset; (v) the time and date; (vi) the device or SIM identification number; and (vii) the terminal device type and operating system (OS) version.

The network provider name (i) is used to identify that the user will be transmitting cell information relating to a particular network. The cell ID and area code (ii and iii) are required to allow the cellular terminal to identify the current cell or sector within which it is located. The signal strength, timing or synchronisation offset (iv) can be used to enhance the accuracy of the location estimate, as described in further detail below. The time (v) is used to provide the exact time when the information was measured relative to the terminal's internal clock. The device or SIM identification (vi) is required to determine which particular cellular terminal has transmitted the information while the device and OS type (vii) is provided in order to solve any compatibility issues that may arise. The above information is transmitted to the server so as to be recorded within the database, as appropriate.

Initially, at the location server a cell of origin step is employed to identify the approximate location of the cellular terminal. When the terminal moves from cell A to cell B, a handover event occurs i.e. the cell ID or area code changes. The software in the terminal detects this. This event acts as a trigger for the cellular terminal to communicate with the server so as to transmit this information to the database. The information can be transmitted as a single message using GPRS or by any other suitable message transport mechanism. The server checks to see if handover A-B exists in the handover database. If it exists then the location given by the best method for that handover is served as the terminal location. If handover A-B does not exist in the handover database, but the reverse handover from B-A does exist then this can be used as the terminal location since it would normally be physically close to the A-B handover location.

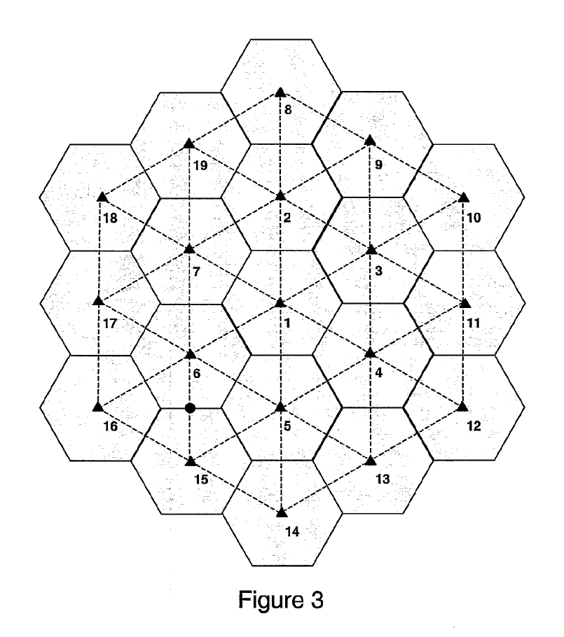

If handover A-B or B-A do not exist in the database, strategic assumptions can be employed to determine the most probable location areas. This can be done using the netlist or adjacency list, which defines how cells are interconnected. The netlist can be derived by observing handover events between adjacent cells. For example, a handover from cell 1 to cell 2 tells that cells 1 and 2 are adjacent and 2 should be added to the netlist row for cell 1. The netlist for cells 1-7 in FIG. 3 might be written as:
1: 2,3,4,5,6,7
2: 8,9,3,1,7,19
3: 9,10,11,4,1,2
4: 3,11,12,13,5,1
5: 1,4,13,14,15,6
6: 7,1,5,15,16,17
7: 19,2,1,6,17,18

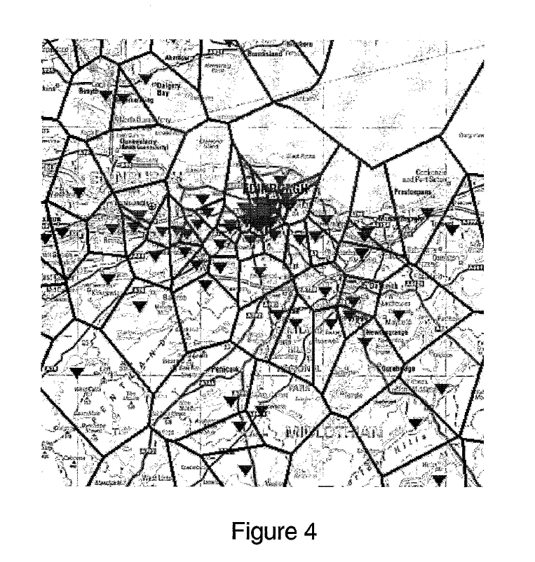

In this regular structure six handovers can be associated with each cell. Not all network interconnections are possible. For example, it is not expected that there will be a handover directly from 3 to 15. As will be appreciated, the netlist for a real network will have a variable number of handovers per cell, for example see FIG. 4. Only the cells and handovers that are actually observed within the netlist can be included.

The netlist, or adjacency list, can be used in a number of ways. The main applications are to fill in missing data in the location or handover database; detect changes in the cellular network; predict the probable route or next location using observed statistics; derive data on the coverage and handover behaviour of cellular networks and repair a location database when the cell-ID of a cell or group of cells is changed, the cell-ID being a unique cellular cell/sector identification, typically although not exclusively comprising a cell number, an area code, a country code and an operator code.

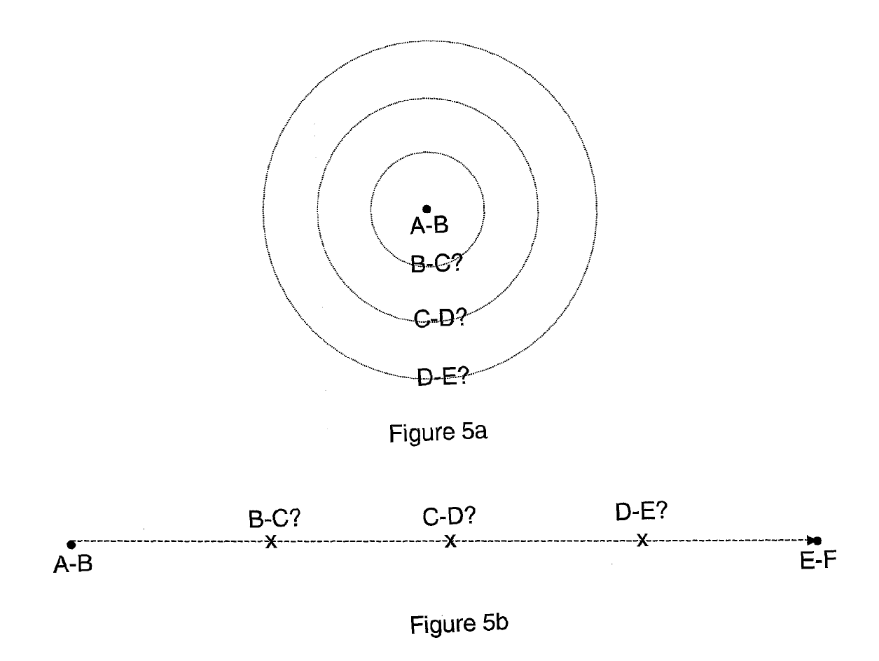

To illustrate how the netlist can be used to fill in data, consider the case where a handover from cell A to cell B is detected and the location estimate for this handover A-B is known. When the terminal moves it will eventually be involved in another handover, say to cell C. If the location of B-C is not known all that is known is that it is a neighbour of handover A-B and so will be some, unknown, distance from A-B. If further handovers C-D and D-E are experienced and their location is not known then the distance from A-B will most probably have increased, but the distance is still unknown. This scenario is illustrated in FIG. 5a. In this scenario, the uncertainty region will continue to grow until the location for another handover can be obtained. When this is achieved then it is known that the other handovers exist in space somewhere between the two known handovers A-B and E-F as illustrated by FIG. 5b. Here, handovers B-C, C-D and D-E are placed between the known handovers with equal spacing.

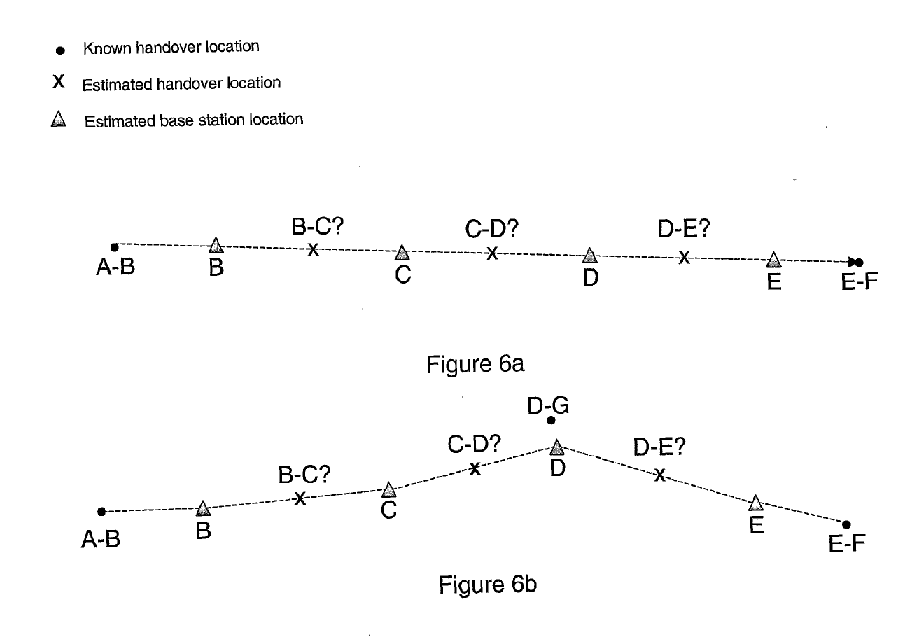

It is possible to derive additional information from the netlist to assist in placing probable handover locations based on information relating to other adjacent cells. Consider FIG. 6a where probable base station locations could be placed in the centre of all the associated handovers. For example, base station D may lie between handover C-D and handover D-E. Now consider FIG. 6b in which additional information is known about the location of handover D-G. Given the locations of handovers involving cell D, it is reasonable to place cell D at the centroid of the observed handovers involving D. By placing cell D using the three handovers, the two handovers C-D and D-E which were at unknown locations can be moved to new locations based on the assumption of them being equidistant between cell C & D and D & E respectively. This in turn causes other adjustments of adjacent base stations and handovers. A number of iterations can be used to allow the unknown handover and base station locations to be repositioned based on the influence of known locations and the netlist interconnections.

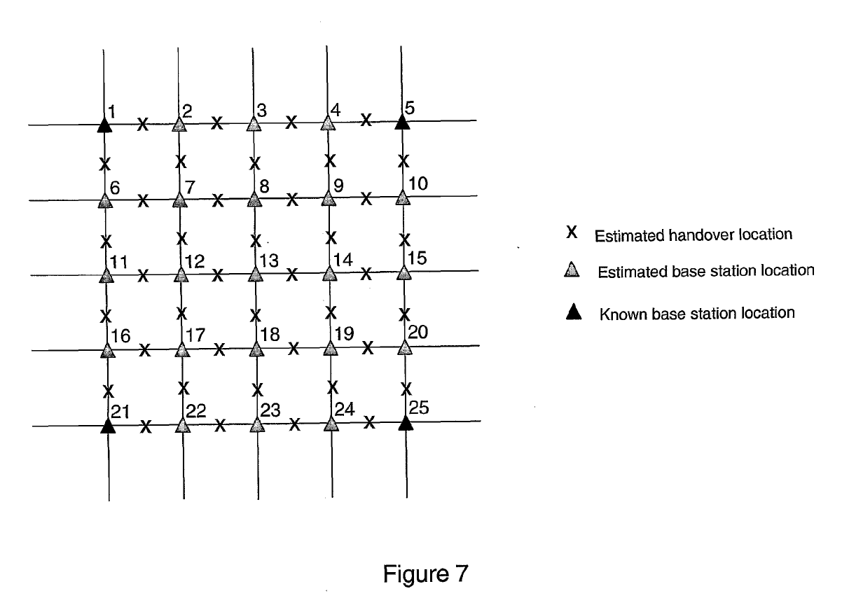

FIG. 7 shows a representation of the following netlist:
1: 2,6
2: 1,7,3
3: 2,8,4
4: 3,9,5
5: 4,10
6: 1,7,11
7: 6,2,8,12
8: 7,3,9,13
9: 8,4,10,14
10: 9,5,15
11: 6,12,16
12: 11,7,13,17
13: 12,8,14,18
14: 13,9,15,19
15: 14,10,20
16: 11,17,21
17: 16,12,18,22
18: 17,13,19,23
19: 18,14,20,24
20: 19,15,25
21: 16,22
22: 21,17,23
23: 22,18,24
24: 23,19,25
25: 24,20

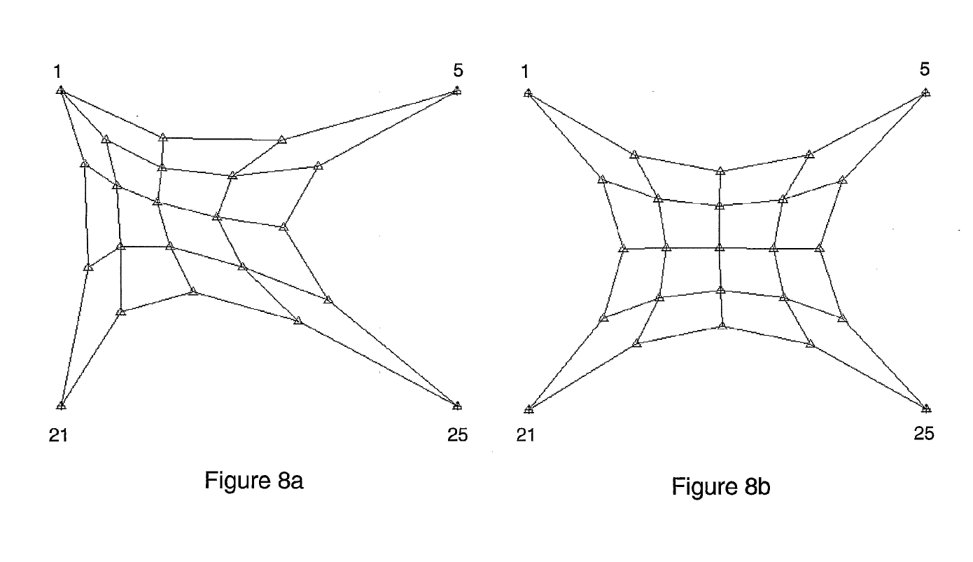

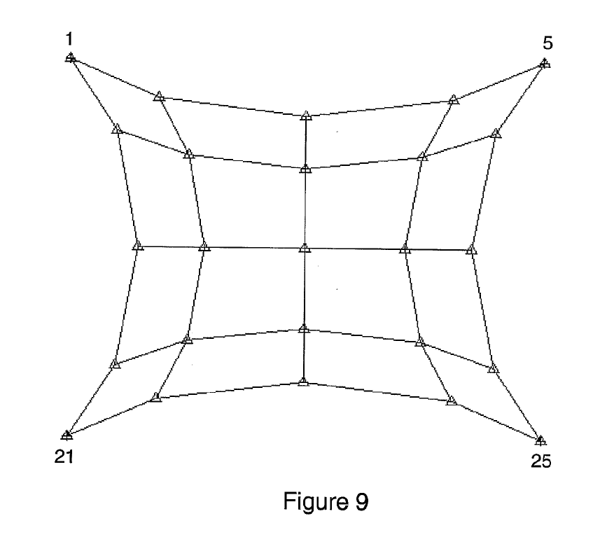

Assume that only location data exists for the location of cells 1, 5, 21 and 25. If the above netlist is drawn and the vertices are drawn between the interconnected cells, the known cells are fixed in place. The position of the other cells can then be determined by modeling the interconnections. For example, positioning of the other cells could be done using some general law of attraction, for example Hookes Law. Hookes Law implies that the tension in each vertex is proportional to its length. This can be calculated via the following algorithm: (1) place the position of all known cells at their location in 2D space; (2) place all cells with unknown location at any location in 2D space; (3) for each cell with unknown location (a) form a 2D polygon from all other cells in the netlist for that cell and (b) compute the centroid for the polygon and use these co-ordinates as the new position for that cell, and (4) repeat (3) several times until the locations of all cells have converged. Running this algorithm three times using the netlist with the corner cells 1, 5, 21 & 25 fixed gives the result shown in FIG. 8a. Running this algorithm until the cells converge gives the result shown in FIG. 8b.

It is also possible to weight the known cells and those closer to known cells more heavily. FIG. 9 shows the results when the weight of each cell location used to calculate the centroid takes account of the minimum distance to a cell with a known location. Other modifications to the algorithm placing the cells can be considered. For example, the following could be used: a minimum and/or maximum cell separation; a model using the vertices in tension rather than compression; handover locations instead of cell locations to position the vertices; handovers and cell locations combined to position nodes and vertices.

Network and netlist data evolves and must be kept up-to-date in order to maintain an accurate location system. Network monitoring via the netlist and netlist statistics allows bulk network performance data to be gathered. Cell coverage plans can be plotted and the most or least common handovers can be found, as can the flow pattern of devices within the network. This and other data derived from the netlist statistics helps with network troubleshooting and network optimisation. By gathering dynamic cell/sector/segment transition data as described above, the netlist can be used to detect changes in the network such as new cells, the removal of cells or the repositioning of cells. The data gathered for the netlist is useful dynamic data that shows how the network is interconnected and how this has evolved and where problems can arise. Areas where coverage is lost and regained can also be mapped out. Because the network is being monitored on-the-fly, in real-time, unlike most network based monitoring, a call does not need to be in progress in order for this data to be gathered.

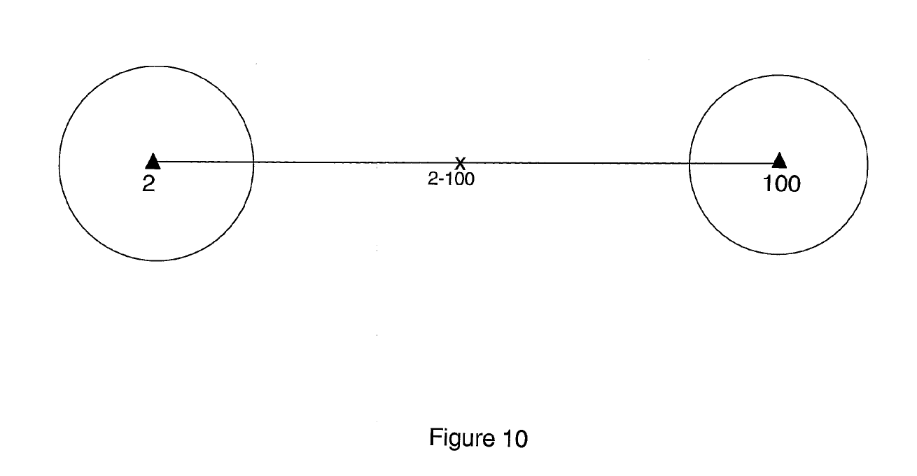

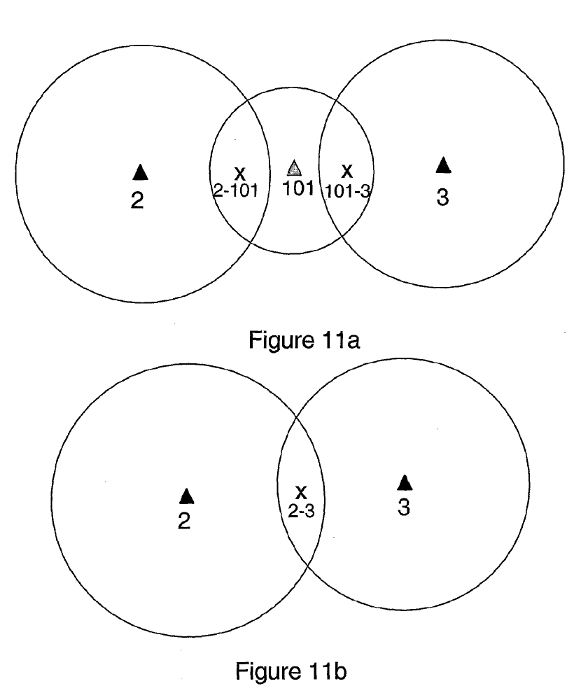

To detect network changes incoming data is monitored and compared with the existing netlist. For example, consider the situation when a previously undetected handover from cell 2 to cell 100 is detected, as shown in FIG. 10. In this case, when the cell data is used to estimate the position of the handover, it is discovered that the two cells are far apart. This suggests that either cell 2 or cell 100 may have been relocated and so the data may have to be quarantined until it is checked and repaired. Monitoring handover activity also allows the addition or removal of cells to be detected. FIG. 11a shows previously undetected handovers 2-101 followed by 101-3. In contrast, the handover 2-3 of FIG. 11b had been observed. In this case, it can be deduced that a new cell 101 has been added somewhere between or adjacent to cells 2 and 3.

Removal or replacement of certain cell numbers can also be determined by detecting changes in handover patterns. For example if a typical hand over sequence of 2-101-3 suddenly stopped and cell 101 was not observed again, but instead a new sequence of 2-326-3 begins to be observed, it is probable that cell 101 has been replaced by cell 326. Further monitoring of handovers involving cells 101 and 326 will confirm that this is, or is not, what has happened.

The netlist data can be used in conjunction with handover data. The handover databases are used to store handover locations against a particular handover event. Not only first order handovers (e.g. handover from cell B to C) are contained but also higher order handover data is stored (e.g. handover from B to C given that the previous handover was A to B). A tally of each handover is also kept and from this the probabilities of a handover or sequence of handovers occurring can be determined in advance. Thus, routes can be predicted and assigned a probability of that route being taken.

Consider the following simple netlist as an example
A: B,D
B: C,D,A
C: E,B
D: E,A,B
E: D,C

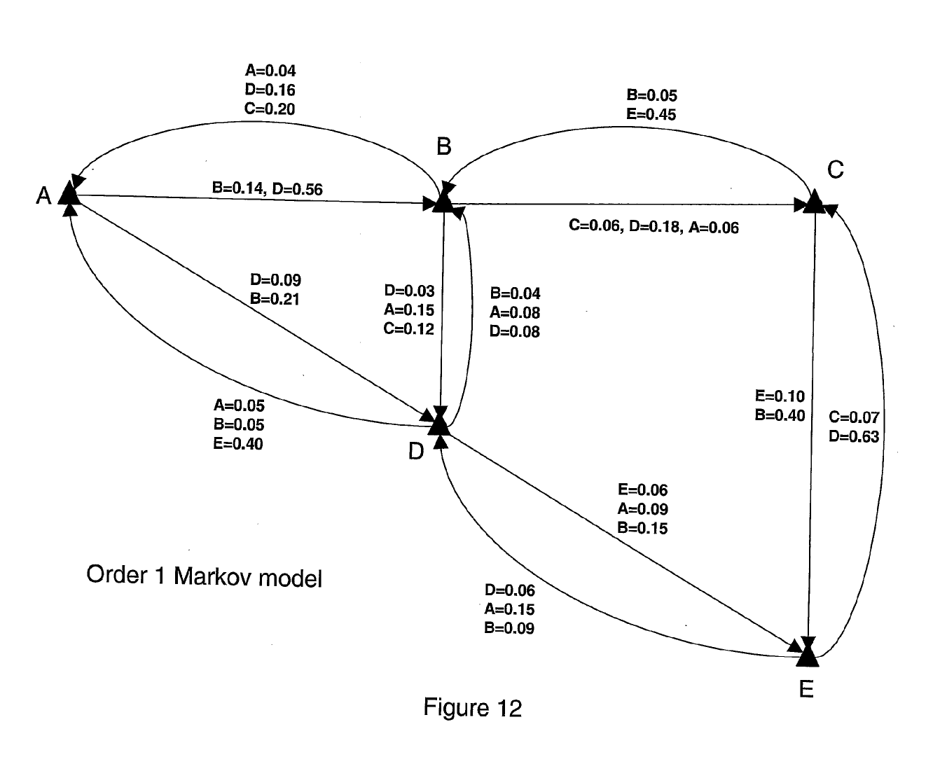

FIG. 12 illustrates the netlist as a state diagram with the interconnections showing the probabilities. As a simple example, the probability of moving from cell A to cell B is 0.7 (0.14+0.56). However the probability of moving from cell A to cell B if the previous cell was D is reduced to 0.56. The netlist combined with handover probability data is useful in predicting probable routes. For example the probability that a person will travel from B to C assuming they were previously in cell A is 0.06. The probability can be extended to consider the probability that they will then travel to cell E. From cell C there are only two possible routes to take, i.e. either back to B or on to D. Since it is already known that the previous route to C was via B the two ratios of interest are (C>E)|B=0.40 and (C>B)|B=0.05. Since these are the only two options the probability of traveling from C to E must be 0.40/(0.40+0.05)=0.89. So the probability that a person will travel from B to C to E given that they were previously in A is 0.06×0.89=0.053.

The netlist, and the statistical data gathered through observation of movement through the netlist is useful for determining network performance, quality of service, for predicting where phones are likely to handover and where dropped calls and poor coverage occur. This data is gathered automatically by the system and a call does not need to be in progress in order for the network data to be collected. The type of data that can be use is: location/area where coverage appears to be lost; location/area where coverage is re-established; prediction of when a handover is likely to occur; statistics and location of cell ping-pongs where repetitive handovers between two cells occur, and a dynamic topology of the network that shows how the network is interconnected and where holes appear. All of the statistics can be gathered based not just on location but can also be related to time. This provides a geo-temporal map of the network behaviour.

Information held in the location databases can be repaired, in particular in the cell location and/or handover location databases, using data from the netlist database. Even if all of the operator cell ID codes were to change, it should be possible to repair the database based on relatively few pieces of known information. This is possible because all of the cell interconnections remain fixed so the netlist is still valid. To repair the database, the new cell ID codes must be remapped onto the old netlist of interconnections. By using a few known positions, these positions can be tied to the old netlist. Using interconnection probabilities from the old netlist and new incoming data from terminals the old cell IDs can be translated to the new ones.

The techniques are similar to those used for filling missing data and for predicting routes. If it is assumed that there is already a netlist of locations but the cell ID numbers have been changed, certain parts of the netlist have to be tied to physical locations. This can be done in a number of different ways e.g. via some GPS measurements or via network requests for location. Once a few anchor points are found the old netlist can be fixed to these points. When a mobile phone has a known location anchor point then the cell ID numbers and handover sequences can be recorded. When the next anchor point is reached or created then the most probable route between the two anchor points is defined using the techniques described previously. The most probable route is used to map the new cell-IDs to the old netlist. When more route or anchor point data is received the procedure is repeated to improve the quality of the cell-ID mapping.

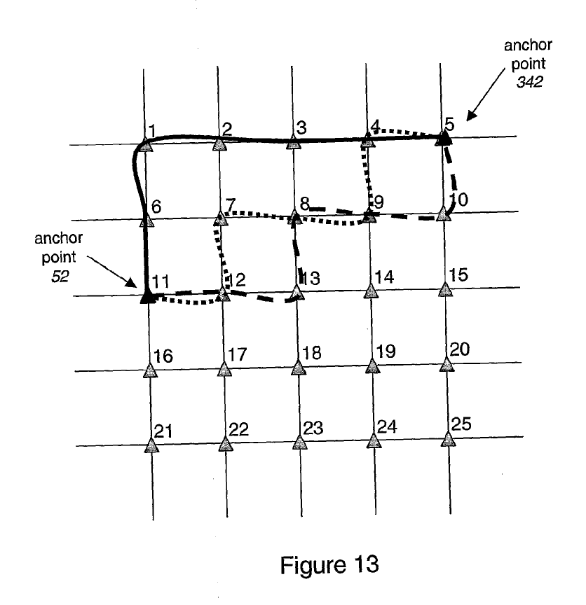

Consider the example shown in FIG. 13. If all cell IDs have been altered it is possible to establish known anchor points at cells 11 and 5, except that these cells now appear as cells 52 and 342 respectively. A route for a phone between 52 and 342 is observed involving 6 handovers. However, only the location for the anchor points 52 and 342 is known. From the netlist it is found that there are several potential routes from 11(52) to 5(342) using 6 handovers. By computation of the probabilities for the potential routes the most probable route or routes can be determined. In this instance, there are three candidate routes based on reasonable probabilities:
11>12>7>8>9>10>5 (dotted line)
11>12>13>8>9>10>5 (dashed line)
11>6>1>2>3>4>5 (solid line)

and one of these should map directly to
52>62<65<210<231>233>342

Maximum likelihood algorithms such as the Viterbi algorithm can be used to choose the probable candidate routes and to discard those that are improbable. In this example, there are 3 candidate routes. However, one will be the most probable based on the conditional probabilities obtained from the historical handover data. Mapping of the most probable route can be used as the correct route temporarily. When more data is obtained relating to these or adjacent cells then the probabilities can be recomputed and the mapping altered if necessary.

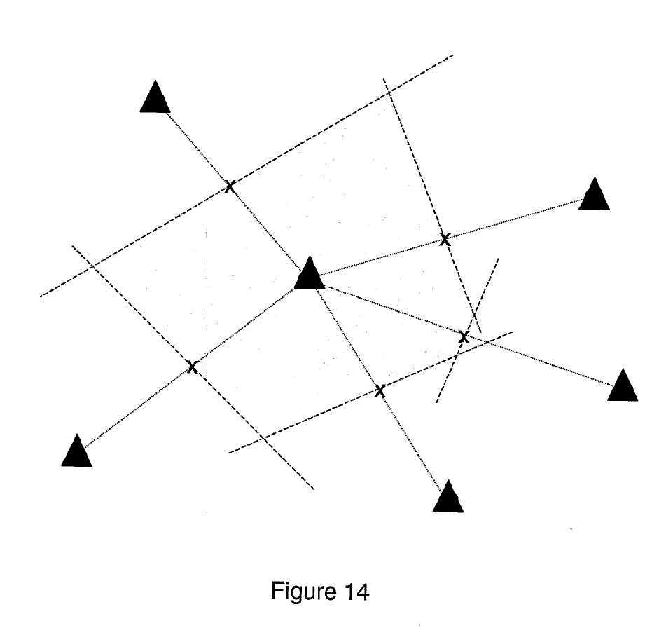

Once the locations for handover events and the netlist showing all handover events that have actually been observed is compiled, it is possible to place the netlist over a geographic map and show the coverage of each cell, as shown in FIG. 4. The coverage can be estimated by drawing a perpendicular to the netlist line between each cell at the handover point. Each of these lines should describe a polygon, which is an estimate of the coverage for that cell, as shown in FIG. 14. Handover behaviour can be observed based on the handover statistic. This data may be plotted as the 3^{rd} dimension on the coverage map. This 3D coverage and handover map is useful for the study of network behaviour and to improve network planning and optimisation.

As well as handover data, changes in timing information, for example signal time of flight or round trip flight time, can be used to predict location. In GSM, this can be estimated by the timing advance (TA) signals. A change in TA signifies a movement to within a certain radius of the cellular mast location with a 550 m resolution. When a delta TA event occurs it could indicate that the distance from the mast was between 0 and 550 m before the change and it is 550 m to 1100 m after the change. Therefore, at the time of the delta, it can be determined that the distance from the mast was 550 m. Combined with the sector coverage data the location of that delta event can be determined, and the TA delta as well as the Cell ID delta can be included within the netlist.

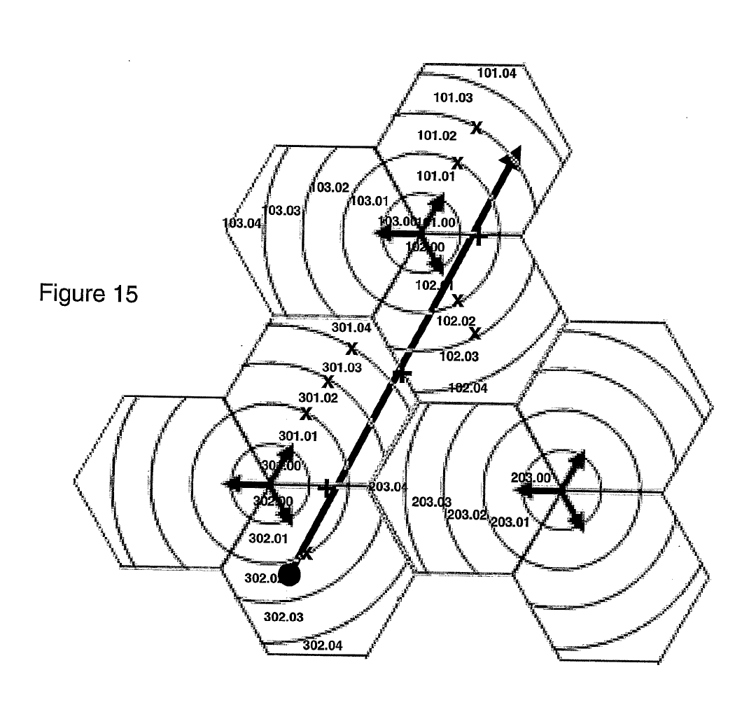

FIG. 15 shows three masts each with three sectors at 120 degrees to each other. The idealised coverage of each sector is represented by a hexagon. Each hexagonal coverage can be divided into a series of arcs representing different signal time of flight or round trip delay, or in the GSM example the TA values can be represented by a series of arcs separated by approximately 550 m (a segment). Each arc segment within a sector has been numbered using the cell ID number as the integer part of the value and a fractional decimal part to represent the timing advance value.

Consider a mobile travelling through this network as represented by the arrow. The sequence of measurements of cell and TA will be gathered as:

302.02, 302.01, 301.01, 301.02, 301.03, 301.04, 102.03, 102.02, 102.01, 101.01, 101.02, 101.03.

This data effectively helps map out the netlist, taking into account the TA values as well as the cell ID values. The netlist can be built in an identical fashion to before, only the extended numbers, including the TA (or other timing parameter) can be taken into account. In the example the netlist for 102.02 would be:

102.02: 102.01, 101.01, 101.02, 102.03, 301.04, 103.02, 103.01.

The predictions of where the changes of TA might take place are marked as crosses on the diagram. These are estimated to be the centre of the arc representing the change of TA. The changes of cell/sector, taking into account the TA, are shown as a plus symbol. When a change of cell occurs and the TA parameter is taken into account for both the current cell and the departed cell, then the accuracy of the estimated location is good compared to the accuracy of the location estimated during a TA change only.

The netlist can use device location history or survey data to determine the next probable location within the netlist based on current and previous locations. The location prediction may take account of the transition probabilities and also the transit times between nodes. For example a normal speed through a part of the netlist can be measured. If a lower speed is encountered at certain times this could indicate traffic congestion or some other reason for a deviation from normal behaviour.

Location can be predicted using probability and conditional probability, e.g. using a Markov model. This can be expanded to include the prediction of the most probable destination(s) (pre-destination) or future waypoint based on current position in the netlist, previous locations and potentially the start point of a journey. Movement within the netlist can also be used to determine, based on probablility, where you are unlikely to be going. For example, moving eastward for many handovers or cells means it is unlikely that the destination or future waypoint will be westwards. This can be useful for eliminating any irrelevant content sent to the phone, e.g. traffic reports will only be for roads that are likely to be encountered, and adverts will not include those for shops in a town which is unlikely to be visited.

Although the above describes scenarios where the netlist is tied to physical locations, this is not essential. Instead, the netlist may be floating, thereby allowing relative locations, but not absolute ones, to be determined. For example, if one phone is located at one point of the netlist, then its relative proximity to another phone can be estimated. This can be done using the live terminals to detect actual network interconnections and determining the minimum number of vertices of the netlist that must be crossed in order to reach the other phone or object within the netlist. Where TA parameters are known at the handovers the approximate size of the cell coverage is known and this can also be factored into the calculation of relative proximity.

The netlist for relative location can float in space and does not require any anchor points to a physical location. The location of any dynamic or static object relative to another object can be determined using the minimum number of ‘hops’ across the network required to join these two together. The cell coverage areas vary in size and so the distance of each hop will vary. The absolute or relative distance measure can be approximated using a normalised hop distance. Alternatively, the size of each cell can be estimated based on the timing advance (TA) number at a handover. If the TA number for a cell at handover is 5 then the radius of that cell can be approximated by 5×550 m.

Relative proximity to objects or other people within the netlist could be useful for determining which group of friends are nearest or which local adverts are relevant to a person. Relative location can also be used for tagging labels to the netlist for the creation of proximity zones and for geofencing, e.g. detecting if a device is leaving an area, entering an area, or is close to a tagged area. Removing the absolute location is potentially useful in overcoming privacy issues concerned with knowing the location of people and sharing this information. By this method even the central location server will be unaware of the physical location of any person.

The implementation of the present invention involves the execution of a software application on the cellular terminal or the network server. However, there are no hardware/firmware alterations required to standard terminals or to the network equipment in order to achieve this implementation. This means that the invention is cost effective to operate since the network operator does not have to supply the location service and so will charge only for the messaging sent across their network. A further advantage is that information contained in the netlist and optionally the location database can be checked to ensure that they are up-to-date. The nature of the invention means that it can be applied to 2nd generation and 3rd generation cellular equipment or indeed any other communications network where netlists are used and handovers can be detected. The particular air interface used is not important for the implementation of this invention.

A skilled person will appreciate that variations of the disclosed arrangements are possible without departing from the invention. For example, whilst the netlist-based techniques are described above in conjunction with handover location detection techniques, it will be appreciated that they could be used independently thereof and in particular with cell of origin techniques, thereby to determine the location of the terminal. Also in addition to the unique cell ID, the area code and the TA or other timing/synchronisation parameter, other useful parameters could be included in the netlist, provided they can be measured in the handset, SIM card or through the network. These parameters include a list of other ‘hearable’ cells, signal strength of current cell, signal strengths of other ‘hearable’ cells. In GSM this data can be obtained from parameters such as the Network Measurement Report (NMR). Furthermore, it is possible to make the measurements of the terminal's behaviour from within the cellular network rather than using the terminal. Accordingly, the above description of a specific embodiment is made by way of example only and not for the purposes of limitations. It will be clear to the skilled person that minor modifications may be made without significant changes to the operation described.

1. A method for detecting the location of a user terminal in a telecommunications network comprising: receiving network information from the terminal and using the signal from the terminal and a netlist to determine or predict the terminal location.

2. A method as claimed in claim 1 wherein the netlist is a floating netlist, and determining the terminal location involves determining the relative location of the terminal.

3. A method as claimed in claim 2 comprising tagging one or more locations within the floating netlist.

4. A method as claimed in claim 1 comprising anchoring at least one point within the netlist to a known physical location and using the at least one anchor point and the netlist to estimate the location of the terminal.

5. A method as claimed in claim 1 comprising using timing information to determine the location of the terminal.

6. A method as claimed in claim 1 comprising determining relative proximity of two objects by establishing a minimum number of hops across cells and/or sectors or segments of sectors and/or cells of the network as defined in the netlist in order to join the two objects together.

7. A method as claimed in claim 6 wherein the cell coverage areas vary in size and so the distance of the or each hop varies.

8. A method as claimed in claim 6 comprising approximating the relative separation of the two objects using a normalised hop distance.

9. A method as claimed in claim 6 comprising using timing information between hops to estimate the size of each cell.

10. A method as claimed in claim 6 comprising identifying objects that are far away.

11. A method as claimed in claim 1 comprising using information received from the terminal to detect changes in the network.

12. A method as claimed in claim 1 comprising using information received from the terminal to detect a change in or up-date the netlist.

13. A method as claimed in claim 1 comprising using information received from the terminal to predict a probable route or next location for the terminal.

14. A method as claimed in claim 13 comprising determining transition probabilities within a netlist for use in predicting the probable route or next location.

15. A method as claimed in claim 1 comprising receiving information from the terminal periodically.

16. A method as claimed in claim 1 comprising receiving information from the terminal when network changes are detected.

17. A system for detecting the location of a user terminal in a telecommunications network comprising: means for receiving network information from the terminal and means for determining or predicting the terminal location using the signal from the terminal and information in a netlist.

18. A system as claimed in claim 17 wherein the netlist is a floating netlist, and the determining means are operable to determine the relative location of the terminal.

19. A system as claimed in claim 17, wherein at least one point within the netlist is associated with a known physical location and the means for determining are operable to use the at least one anchor point and the netlist to estimate the location of the terminal.

20. A system as claimed in claim 17 comprising using timing information to determine the location of the terminal.

21. A system as claimed in claim 17 wherein the determining means are operable to determine the relative proximity of two objects by establishing a minimum number of hops across cells and/or sectors or segments of sectors and/or cells of the network as defined in the netlist in order to join the two objects together.

22. A system as claimed in claim 21 wherein the cell coverage areas vary in size and so the distance of the or each hop varies.

23. A system as claimed in claim 21 wherein the determining means are operable to approximate the relative separation of the two objects using a normalised hop distance.

24. A system as claimed in claim 17 wherein the determining means are operable to use timing information between hops to estimate the size of each cell.

25. A system as claimed in claim 17 that is computer implemented.

26. A computer program, for use in a telecommunications location detection system, preferably on a computer readable medium or data carrier, the computer program having code or instructions for using network information received from a user terminal and information in a netlist to determine or predict the terminal location.

27. A computer program as claimed in claim 26 wherein the netlist is a floating netlist, and the program is operable to determine or predict the relative location of the terminal.

28. A computer program as claimed in claim 26, wherein at least one point within the netlist is associated with a known physical location and the program is operable to use the at least one anchor point and the netlist to estimate the location of the terminal.

29. A computer program as claimed in claim 26 that is operable to use timing information to determine the location of the terminal.

30. A computer program as claimed in claim 26 that is operable to determine the relative proximity of two objects by establishing a minimum number of hops across cells and/or sectors or segments of sectors and/or cells of the network as defined in the netlist in order to join the two objects together.

31. A computer program as claimed in claim 26 that is operable to approximate the relative separation of the two objects using a normalised hop distance.

32. A computer program as claimed in claim 26 that is operable to use timing information between hops to estimate the size of each cell.

33. A method for monitoring a telecommunications network comprising receiving network information from a terminal that is interacting with the network and using that information to up-date a netlist and/or location database.

34. A method as claimed in claim 33 comprising updating the location database when the cell-ID of a cell or group of cells is changed.

35. A method for monitoring a telecommunications network comprising receiving network information from a terminal that is interacting with the network and using the information received from the terminal and a netlist to derive data on coverage and/or handover behaviour of the network.

36. A method for monitoring connections in a network comprising receiving network information from a terminal that is interacting with the network; and using the information received from the terminal and a netlist to detect changes in the network.

37. A method monitoring a telecommunications network comprising receiving network information from at least one terminal moving within that network and using the received information to construct or up-date a netlist.

38. A method as claimed in claim 35 comprising storing the netlist.
